(19) United States
(12) Patent Application Publication
(10) Pub. No.: US 2014/0135574 A1
(43) Pub. Date: May 15, 2014

(54) PENILE PROTHESIS

(71) Applicant: GILBERTO ABU GANNAM, PIRACAIA - SAO PAULO (BR)

(72) Inventor: GILBERTO ABU GANNAM, PIRACAIA - SAO PAULO (BR)

(21) Appl. No.: 14/078,959

(22) Filed: Nov. 13, 2013

(30) Foreign Application Priority Data
Nov. 13, 2012 (BR) 10 2012 0290197

(51) Int. Cl. A61H 19/00

(52) U.S. Cl. CPC A61H 19/44
USPC 600/38

(57) ABSTRACT

An external penile prosthesis includes a manufactured device easily applied by the user himself and characterized by two layers of flexible rectangular format of latex forming an internal surface and an external surface, and between the layers of the prosthesis are positioned several fin-like stays attached to the latex which may or may not be parallel and equidistant, between such stays and the adherable areas demarcating the lateral margins, upper and lower, is included an adherable mating label or sticker for the user's specific purpose. The user's application is accomplished by emplacement, around the penis, between the prepuce and scrotum, and closing by the joining of the two adherable areas.

### 1.—INTRODUCTION

This patent of the invention relates to a penile prosthesis comprised of an external prosthesis made of latex fabric of rectangular shape and appropriate weight, which is formed by two layers of latex configuring a body with two surfaces, an internal surface and an external surface; between the two surfaces of the prosthesis, there are several fin-like stays fixed between the two layers of latex in parallel formation with respect to one another, and the two adhering areas that delimit the external margins include an adhering sticker or label specific to its purpose of joining the two sides and forming a tubular sheath.

### 2.—FIELD OF APPLICATION

The field of the present invention, a penile prosthesis, is the area of medicine, preferably the area of erectile dysfunction, that relates to the field of biomechanics, since the development of this prosthesis makes it feasible to use it as a substitute for surgically implanted prostheses.

### 3.—OBJECTIVES

Among the primary objectives of this penile prosthesis should be noted that it:
Adapts the prosthesis externally around the penis simply and quickly.
Eliminates problems of erection and penetration.

### 4.—STATE OF THE ART

It should be pointed out that there are various alternatives on the market within the current state of the art, among them surgical procedures, devices, and other means to treat erectile dysfunction, emphasizing that the reasons for the necessity of vascular replacements, such as vascular grafts, include injuries of various types, such as thromboembolism, atherosclerosis, vascular stenosis, with cardiovascular atherosclerosis being the leading cause of mortality from acquired diseases throughout the Western populations. (EAGLE KA, et al., 2004; BAGUNEIDMS, et al., 1999).

With a view towards placement of a product that meets the needs of the market, an extensive search was undertaken in the database of the INPI—Instituto Nacional da Propriedade Industrial—for the purpose of verifying applications and patents of penile prostheses filed in this Institute.

In the search conducted the following prior art was found:

PI0903030-1 deposited on 20.08.2009 under the title of “SYSTEM OF EXTERNAL PENILE PROSTHESIS TO HELP IN PREMATURE EJACULATION AND ERECTION”, which states that the use of this device will help to contain the precipitated desire that leads to premature ejaculation, allowing the user better control for the inhibition of this precipitated feeling; this, combined with manual treatments recommended by specialized doctors, will bring great benefits to patients or users, gaining better control in sexual intercourse, with the help of a physical device for their period of treatment. The prosthesis is introduced on the penis (P) just touching the base (3) in the pelvic region and on the scrotum; if there is the intention of using a condom, this must be introduced normally, being facilitated due to a narrowing (5), leading the ring of the condom to be retained inside the annular cavity (4), and therefore properly ready for the sexual act: even if there is an ejaculation, this prosthesis will allow a kind of erection to be maintained, so that the end of sexual intercourse can be reached with the partner.

An analysis of the prior art referenced above ascertains that the patent of the invention at issue has no similarity thereto, thus there is no technical or legal impediment to granting the patent claimed.

### 5.—TECHNOLOGICAL ADVANCEMENT

The technological advancement of this penile prosthesis concerns and is characterized by the following;
External tubular-sheath type prosthesis, application of which is performed by positioning the prosthesis around the penis between the scrotum and the prepuce, closing through its two adhering areas, being that the prosthesis remains rigid due to the fin-like stays fixed between the two layers that compose the prosthesis.
The prosthesis is indicated for people suffering from erectile dysfunction, since, according to studies carried out, 75% of dysfunctions arise out of some organic problem, and 25% are due to physical factors. The vast majority of men who suffer from this problem also suffer from diabetes, coronary artery diseases or hypertension. Long-term depression also predisposes towards erectile dysfunction; moreover tobacco, excess alcohol, lack of exercise, excessive weight and high cholesterol are direct causes of impotence.
The prosthesis presents an immediate result due to its rigidity, allowing penetration to be performed even if the penis is semi-erect.
The prosthesis can be used by men of any age, managing to maintain normal sexual relations, without the use of drugs and without surgery.

### 6.—DESCRIPTION OF THE FIGURES

To obtain a full and complete view of the composition of the penile prosthesis, now at issue and subject matter of the present patent of the invention, drawings are attached in the appendix, to which reference is made, as follows:

FIG. 1: Corresponds to a schematic view in perspective of the opened latex prosthesis.

FIG. 2: Represents a schematic view, in an exploded perspective, illustrating the prosthesis, the two layers, both internal and external, the fin-like stays and the two adhering areas.

FIG. 3: Illustrates a schematic view of the prosthesis placed on the penis.

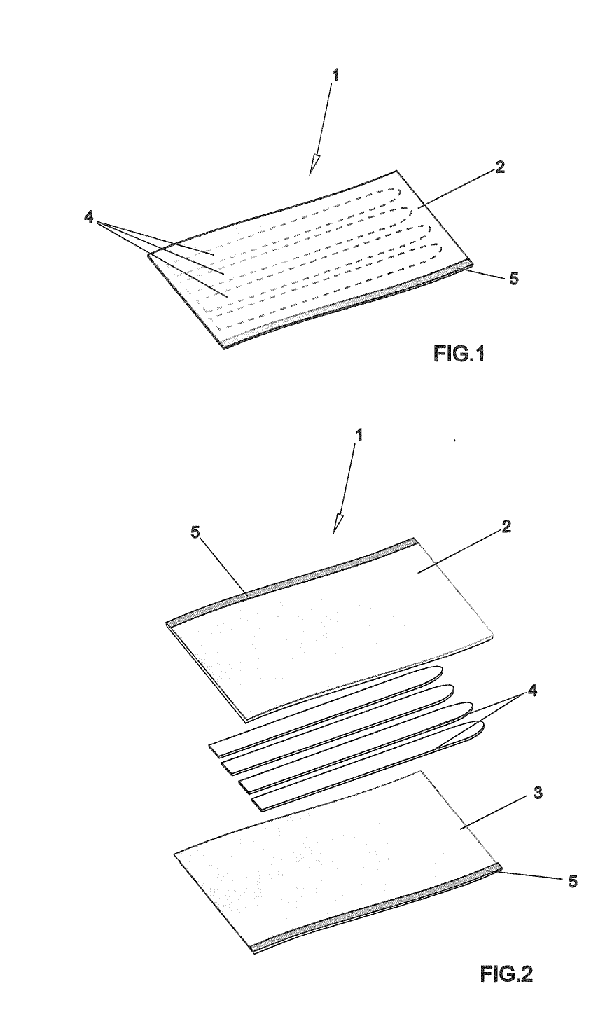

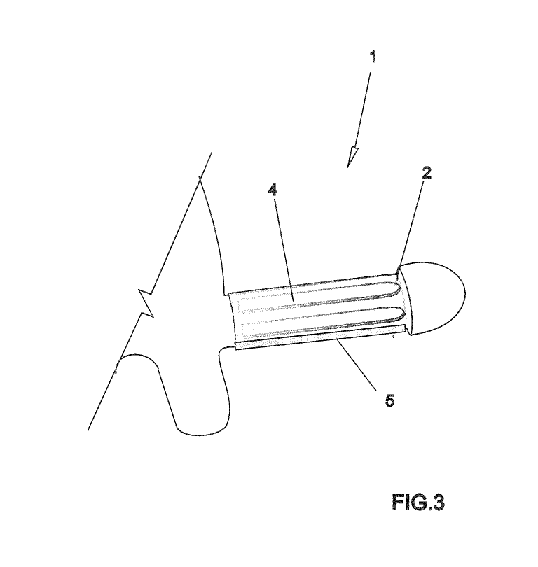

### 7.—DESCRIPTION OF THE INVENTION

As inferred from the accompanying drawings that are an integral part of this application, the penile prosthesis (1) comprises a manufactured device of external application that is easily applied by the user himself, being characterized by a rectangular-shaped body formed by two layers, preferably of flexible latex, an inner surface or layer (2) and an outer surface or layer (3), and between these two layers of latex there are several fin-like stays (4) attached to the latex.

It is important to emphasize that the positioning of the fin-like stays (4) may or may not be parallel to and equidistant from each other, and that the two adhering areas (5) are arranged oppositely, one on the upper side and the other on the lower side.

When applying this prosthesis, its rectangular shape allows it to be applied by placing it around the penis, between the prepuce and scrotum and closing it by joining the two adhering areas, i.e. the prosthesis forms a tubular sheath around the penis.

### 8.—CONCLUSION

Based on all of the above descriptions and illustrations it is evident that this is a penile prosthesis (1) that fits perfectly within the rules governing the patent of the invention and that fills an important gap in the market, all the more so because it offers the advantages presented in the corresponding paragraph of objectives. Based on all of the above statements it consequently merits the corresponding patent.

1. Penile Prosthesis (1) is comprised of a manufactured device for external application, easily applied by the user himself, characterized by comprising a rectangular-shaped body formed by two layers, preferably of flexible latex, an internal surface or layer (2) and an external surface or layer (3), and between these two layers of latex there are positioned several fin-like stays (4) attached fixedly to the latex, as well as also provision for two adhering areas (5) demarcating the lateral margins, upper and lower.
